(19) United States
(12) Patent Application Publication
(10) Pub. No.: US 2014/0250370 A1
(43) Pub. Date: Sep. 4, 2014

(54) Systems And Methods For Delivering Platform-Independent Web Content

(71) Applicant: SparkOffer, Inc., Mansfield, TX (US)

(72) Inventors: Gregory Scott Woodard, Mansfield, TX (US); Lance David Auburg, Farmers Branch, TX (US)

(73) Assignee: SparkOffer, Inc., Mansfield, TX (US)

(21) Appl. No.: 13/970,227

(22) Filed: Aug. 19, 2013

Related U.S. Application Data
(60) Provisional application No. 61/771,180, filed on Mar. 1, 2013.
(60) Provisional application No. 61/818,384, filed on May 1, 2013.

(51) Int. Cl. G06F 17/22

(52) U.S. Cl. CPC G06F 17/2264
USPC 715/236

(57) ABSTRACT

A system and method for providing content on a plurality of platforms. A reference to content and a selection of a selected portion of the content is received from a client device. A container suitable for a target platform is generated. The content portion is transformed such that the transformation includes the selected portion within a boundary associated with the container. The transformation may be associated with the container. The container may then be published for access over a network by means of a browser. Upon accessing of the container, a user's browser may request the transformation and render the transformation within the container. The method may include using a client's credentials to add the container to a social networking profile of the client.

### RELATED APPLICATIONS

This application claims the benefit of U.S. Provisional Application Ser. No. 61/771,180, entitled “Display Page Identification Application,” filed Mar. 1, 2013, the disclosure of which is incorporated herein by reference in its entirety.

This application also claims the benefit of U.S. Provisional Application Ser. No. 61/818,384, entitled “Display Page Identification Application,” filed May 1, 2013, the disclosure of which is incorporated herein by reference in its entirety.

### TECHNICAL FIELD

This invention relates to systems and methods for providing web content on various platforms in a platform-independent manner.

### BACKGROUND

Standard formatting languages such as Hypertext Markup Language (HTML) and programming languages such as Java have fulfilled the goal of providing web content that executes the same on many different platforms. However, even if web content is rendered or executed identically, on some devices this may be insufficient. For example, on a mobile phone with a small screen, content may be too small to see and interface elements too small to be accessed by means of a touch screen.

Many authors of web content respond to this problem by generating multiple versions of web content for, for example, desktop and mobile devices. However, this negates the platform independence that has been achieved and multiplies the cost of developing web content.

This application is directed to an improved approach for providing the same content across multiple platforms without requiring modification of underlying code.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network that may implement embodiments of the present invention;

FIG. 2 is a schematic block diagram of an exemplary computing device;

FIG. 3 is a process flow diagram of a method for generating platform-independent content in accordance with an embodiment of the present invention;

FIG. 4 is a schematic block diagram of a system for ingesting web content by a proxy server in accordance with an embodiment of the present invention;

FIG. 5 is an isometric view of a viewport and viewport container in accordance with an embodiment of the present invention;

FIG. 6 is a process flow diagram of a method for accessing platform-independent content in accordance with an embodiment of the present invention;

FIG. 7 is a schematic block diagram of a system for providing access to transformed web content by a proxy server in accordance with an embodiment of the present invention;

FIG. 8 is a process flow diagram of another method for responding to user interactions in accordance with an embodiment of the present invention;

FIG. 9 is a schematic block diagram of a system for responding to interactions with un-transformed web content by a proxy server in accordance with an embodiment of the present invention;

FIG. 10 is a process flow diagram of another method for ingesting web content in accordance with an embodiment of the present invention;

FIG. 11 is a process flow diagram of a method for providing access to transformed web content in accordance with an embodiment of the present invention;

FIG. 12 is a process flow diagram of a method for authenticating a service in accordance with the invention with a social networking service; and

FIG. 13 is schematic block diagram of an interface in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The invention has been developed in response to the present state of the art and, in particular, in response to the problems and needs in the art that have not yet been fully solved by currently available apparatus and methods. Accordingly, the invention has been developed to provide a system for method for providing access to content. The method may include receiving at least one of a reference to the content and the content from a client device and receiving a selection of a selected portion of the content from the client device. The method may further include generating a container suitable for a target platform and transforming at least a portion of the content to generate a transformation such that the transformation represents the selected portion within a boundary associated with the container. The transformation may be associated with the container. The container may then be published for access over a network by means of a browser.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

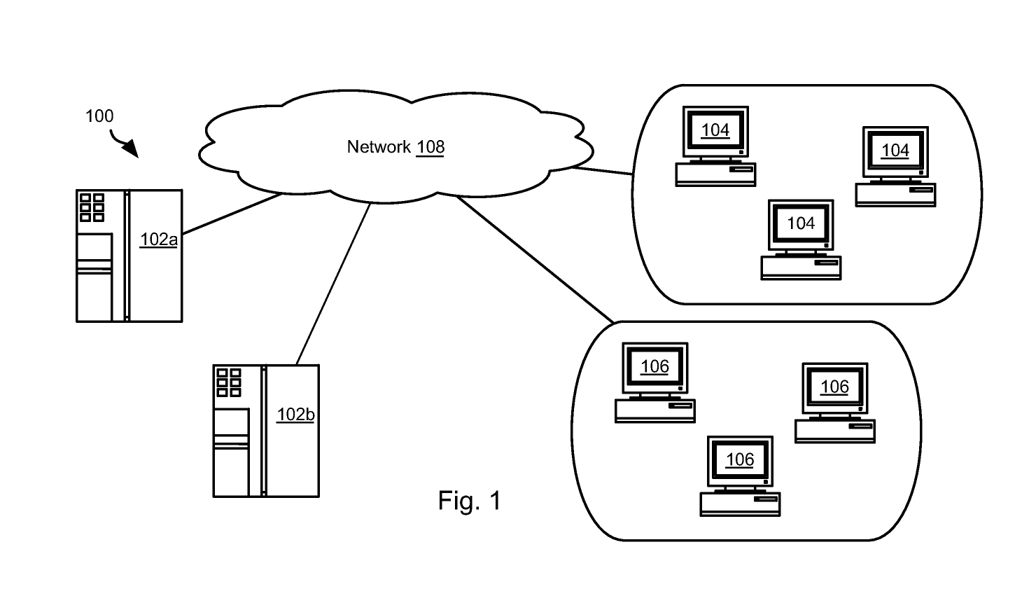

FIG. 1 illustrates a system 100 in which methods described hereinbelow may be implemented. The system 100 may include one or more server systems 102a, 102b that may each be embodied as one or more server computers each including one or more processors that are in data communication with one another. The server systems 102a, 102b may be in data communication with one or more client workstations 104 and one or more user workstations 106. The workstations 104, 106 may be embodied as a laptop or desktop computer, tablet computer, smart phone, or any other computing device.

Some or all of the servers 102a, 102b, workstations 104, and user workstations 106 may communicate with one another by means of a network 108. The network 108 may be embodied as a peer-to-peer connection between devices, a connection through a local area network (LAN), WiFi network, the Internet, or any other communication medium or system.

The illustrated system 100 is just one example of a networked system that may be visualized according to method described herein. The number of clusters of workstations 104, 106, servers, networks 108, and the arrangement and connections between these components may have any arbitrary configuration and may be organized according to any principle for designing such networks. As noted above, large networks may be readily visualized according to the methods disclosed herein.

In the illustrated system 100, server system 102a may be a proxy server performing methods for providing platform-independent web content. The server system 102b may be a system providing access to an interface for which platform-independent is generated according to methods disclosed herein. For example, the server system 102a, may provide access to a social media network and interface.

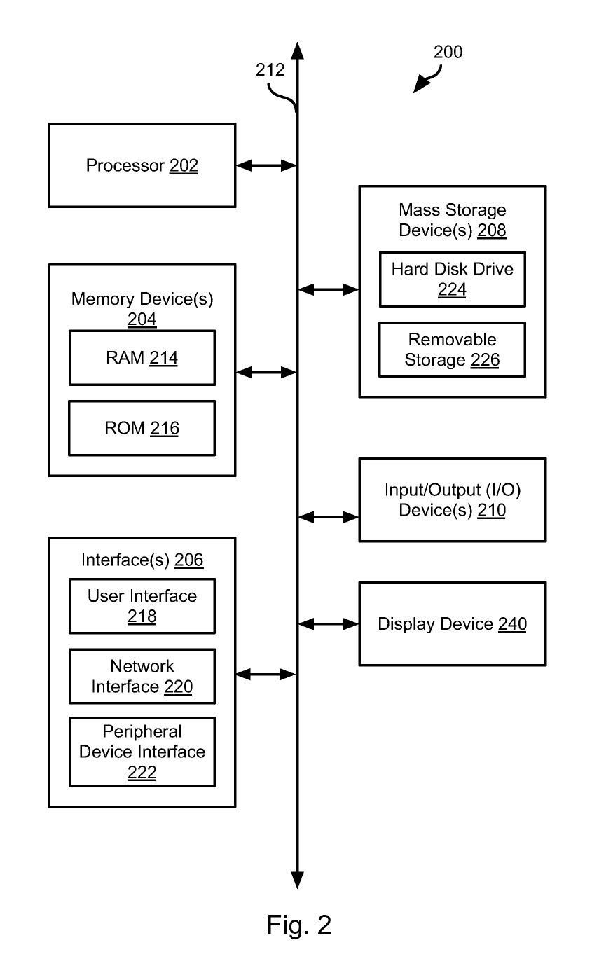

FIG. 2 is a block diagram illustrating an example computing device 200. Computing device 200 may be used to perform various procedures, such as those discussed herein. A server system 102, workstation 104, and workstation 106 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, tablet computer and the like.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more user interface elements 218. The interface(s) 206 may also include one or more peripheral interfaces such as interfaces for printers, pointing devices (mouse, track pad, etc.), keyboards, and the like.

Bus 212 allows processor(s) 202, memory device(s) 204, interface(s) 206, mass storage device(s) 208, and I/O device(s) 210 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

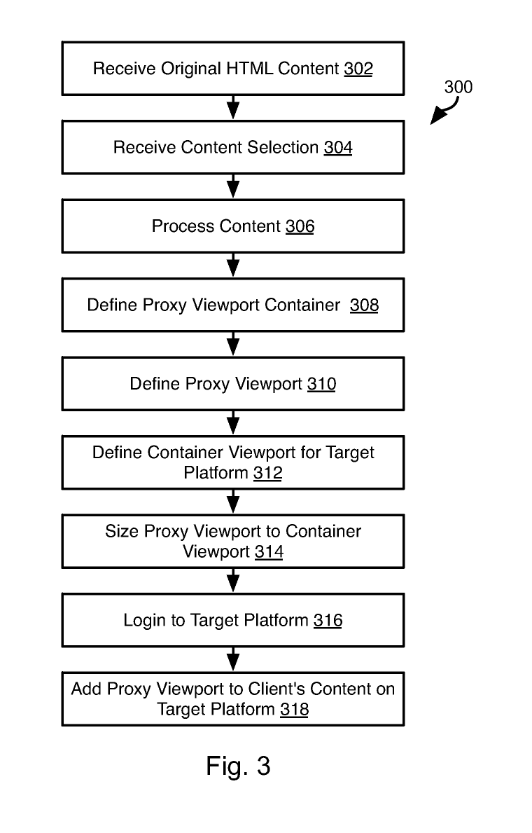

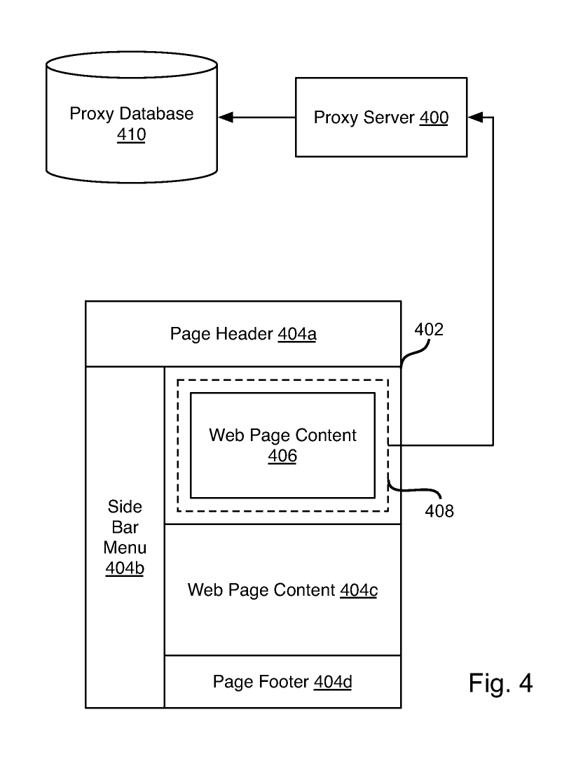

Referring to FIGS. 3 and 4, a method 300 may be executed by a computing device, such as the server system 102a. The method 300 may include receiving 302 original web content or a pointer thereto (e.g., URL). The web content may include an HTML document, dynamic web content, and/or other object accessible and displayable in a browser. The method 300 may further include receiving 304 a selection of less than all of the received 302 content for display.

For example, referring to FIG. 4, a proxy server 400, such as a proxy server 400 executed by the server 102a, may receive reference to a web page 402 that includes a number of elements such as a page header 404a, side bar menu 404b, non-selected content 404c, page footer 404d, or other elements. The proxy server 400 may perform methods disclosed herein on behalf of clients as part of a Software as a Service (SaaS) platform offered to the clients. The web page 402 further includes content 406 that is selected by a client. The selection may be received on a client device and transmitted to the proxy server 400. The selection may be specified by defining a boundary 408 that includes the portion of the web page. The selection may also be specified by selecting an object or segment of the web page 402 including the content 406. The selection may also be received by specifying absolute or relative coordinates with respect to a reference point in the web page.

The selection may be transmitted to the proxy server 400. The selection may be transmitted to the proxy server 400 as coordinates defining the boundary 408, as an identifier for the object or segment defining the selected content 406, or the like. The proxy server 400 may then process the web page 402 and/or selected portion 406 according to the method 300 and store the result in a proxy database 410.

Referring again to FIG. 3, one or both of the web page and the selected portion may be processed 306. Processing may include some or all of sanitizing and normalizing display value data. Sanitizing may include checking for and removing viruses or vulnerabilities. Normalizing may include replacing specifications of distances, positions, sizes, or other attributes in absolute terms with scaled values, e.g., replace a width W specified in pixels or units of length with a relative width αw, where w is a base width, which may or may not be equal to W, and α is a scaling factor applied to one or both of the web page and the selected portion. For example, many items of content may be specified having a fixed number, e.g., 810, of pixels. Instead, a width-to-scale ratio may be used to specify a width. In some embodiments, processing 306 the web page and/or the selected portion may include generating an overlay for the web page and or the selected portion. The overlay may be content independent and different from the actual content of the web page. In some embodiments, a plurality of overlays for a plurality of different target platforms may be generated. An overlay may include imagery and/or text and may be displayable in combination with the web page and/or selected portion. For example, the overlay may be a frame or border surrounding the selected portion or have some other configuration.

Normalizing may overcome any obfuscation in the web page and/or selected portion. In particular, normalizing may relate the ratio of specific values as applicable to identified HTML elements within a document, even if those elements identified are split up into sub elements with the intent of obfuscation by spreading final computed CSS (customized style sheet) Values across one or more split up elements. Normalizing may include interchanging absolute or relative anchors from left to right, or from top to bottom such that there is no significant difference in a final visual result. The normalization process is therefore not deterred by obfuscation through HTML element separation with or without using combinations of CSS inheritance, or overrides with use of more specific CSS Selectors or use of the “!important” suffix to achieve the same Computed CSS Unit Measurement Ratio Contrast. In some embodiments, the content as processed 306 may be stored for later use in response to a request for the content, such as in the proxy database 410.

For example, the method 300 may include defining 308 a proxy viewport container suitable for adapting to a specific platform. A suitable proxy viewport container may be an HTML object, such as a “div wrapper.” The method 300 may further include defining 310 a proxy viewport suitable for adaptation to a target platform. The proxy viewport container may be a parent of the viewport in a Document Object Model (DOM) hierarchy of an HTML document including the viewport. The viewport container may provide a relatively positioned container and hide any elements overflowing from the viewport. The viewport's size, e.g., height, may be specified in CSS units. The height of the proxy viewport container may be specified by the client, such as by means of data transmitted with a request invoking execution of the method 300 with respect to the received 302 content and received 304 content selection. The height of the proxy viewport container may be set equal to a height of the proxy viewport by default. In some embodiments, only the proxy viewport is defined and a proxy viewport container therefor is not defined.

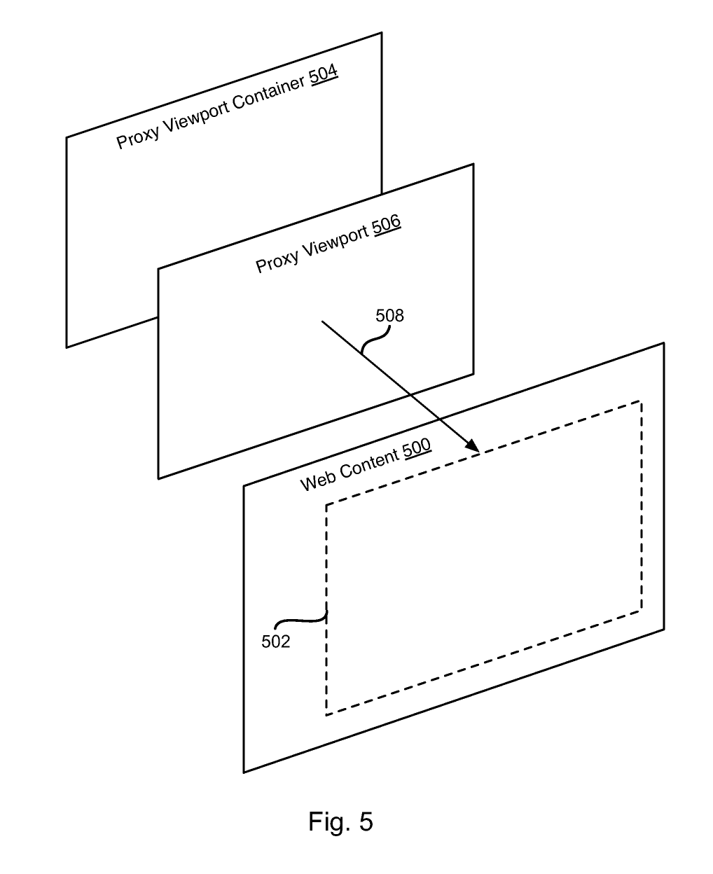

Referring to FIG. 5, an illustration of the relationship between the received 302 content, proxy viewport, and viewport container. As shown web content 500 includes a selected portion 502. A proxy viewport container 504 is some or all of sized and positioned to cover the selection 502 with a remainder of the content 500 positioned outside of the proxy viewport container. The proxy viewport 506 may likewise be sized and/or positioned to conform to the selected portion 502 such that a remainder of the content 500 is positioned outside of the proxy viewport. The proxy viewport 506 may contain a reference 508 to the web content 500, such as a processed version of one or both of the web content 500 or the selection 502, e.g., processed to sanitize and normalize as described above.

Referring again to FIG. 3, the remaining steps of the method 300 may be executed with respect to a specific platform either in advance of an actual request from such a platform or upon receiving a request from a specific platform. Examples of platforms include specific devices, specifically those with limited screen space (e.g., mobile phones, a “smart” refrigerator or other appliance). Platforms may also include an interface displayed on any device that provides a field or forum for posting of content within a specified frame or subject to other constraints of area, data amount, or the like. For example, a platform may include Facebook™, LinkedIn™, FourSquare™, Twitter™, or some other blogging or social networking forum that provides the opportunity to upload content subject to one or more of the above-mentioned constraints.

For example, a container viewport may be defined 312 for a target platform. In some embodiments, the container viewport is an HTML iframe element that may be embedded within a DOM. The container viewport may define different market fronts for the same content. The container viewport may be defined by a plugin, such as for constant contact. For example, the target platform may be within a third party system, such as Constant Contact™, as facilitated by a plug in with that third party. The container viewport may provide a display of pre-existing pages that is suitable for the smaller screens of mobile devices.

The DOM and/or iframe may have specified width measured in CSS units. The container viewport's height may be set based on a specified or rendered content size within the nesting of the container viewport using a cross-domain solution, such as the Facebook™ AutoGrow method. The container viewport may reference as a source (“src”) thereof a Uniform Resource Locator (URL) that references the defined 308 proxy viewport container and/or defined 310 proxy viewport. In some embodiments, an image of the contents of the proxy viewport may be displayed in the container viewport (e.g., JPEG, PNG, etc.). This image may function as a link that when clicked will request a full version of the content form the proxy server 400. In other embodiments, a rendering of HTML code, as transformed as described herein, for the selected content is displayed in the container viewport by way of the proxy viewport.

The method 300 may further include sizing 314 the proxy viewport to the container viewport. For example, a CSS scale transform may be applied to the proxy viewport. Sizing 314 may include creating a zoom effect whereby elements are displayed larger without affecting underlying box model properties. Where a proxy viewport is used, sizing may include applying a new calculated width to the proxy viewport. For example, the new width of the proxy viewport may set equal to a ratio of the container viewport's width and a scale defined for the container viewport plus an absolute value of a horizontal offset of the viewport container.

In some embodiments, sizing 314 the proxy viewport may include specifying a transformed positioned for the proxy viewport. In such embodiments, the position may be specified using anchor points to some or all of position it, scale it, and define a height thereof.

In some embodiments, CSS units may be used to specify various CSS properties for the proxy viewport to obtain a desired visual effect. Such properties may include top (or bottom), left (or right), position (relative, absolute, or fixed), scale, height, width (width=ViewportContainerWidth/scale+abs/(Offsetx). The “scale” value of the preceding equation may be that of the container viewport in some embodiments and that of the proxy viewport in other embodiments. Using CSS properties may also include using some or all of a browser vendor-specific scale, transform, and matrix properties or methods such as may be used with Mozilla, Opera, Webkit, Microsoft, and the like. For example, these may include some or all of ms-transform: scale(scale), ms-transform-origin: X Y, moz-transform: scale(scale), moz-transform-origin: X Y, o-transform: scale(scale), o-transform-origin: X Y, webkit-transform: scale(scale), ms-filter: rpgid: DXImageTransform.Microsoft.Matrix(M11=scale, M12=X, M21=Y, M22=scale, SizingMethod=‘auto expand’).

In some embodiments, the sizing 314 of the proxy viewport provides seamless proportional element integration of elements from the selected content into a DOM, HTML document, or other interface. The integration may be seamless in that other than specifying the received 304 selection, no client action with respect to the original web content is required. For example, any section of the received 302 web page, such as a dynamic web element in the web page, may be specified using some or all of X, Y, and Z coordinates. This section may then be viewed within any target environment using the methods described herein. In this manner, clients may maintain a single web presence and content management platform (“source environment”), such as a corporate or product website. The same content may then be deployed to a plurality of additional channels, such as any of the above-mentioned social media platforms, mobile operating systems (iOS™, Android™, Blackberry Mobile OS™, Microsoft Mobile OS™, Glass™, and the like), smart appliance platforms, in-dash displays in automobiles, or any other environment that supports display of HTML content. Additionally, multiple selections with different X, Y or Z coordinates may be defined to display different portions of the received 302 web page and to provide different sizes and aspect ratios for devices having different display sizes.

As noted above, a proxy viewport may be embedded in a viewport container, such as an iframe. The iframe may be part of a social media target platform, such as Facebook™. In some embodiments, the proxy viewport may function as, or include, a link to the original received 302 web page or other web page that includes the content selection, which may be a dynamic web element. For example, the user may provide data enabling the proxy server 400 to login 316 to a client's account and proceed to add 318 a reference to the proxy viewport container to a viewport container in profile data associated with the client. For example, a link on a Facebook™ timeline may be generated that references the proxy viewport and/or proxy viewport container. For example, a viewport container (e.g., iframe) referencing the proxy viewport container and/or proxy viewport may be stored as an entry in the client's timeline or elsewhere on the client's social networking profile.

In some embodiments, the container viewport may be added by a client to a web page. The container viewport may also be associated with a redirect such that upon receiving a request form a target platform, such as by the proxy server 400, the container viewport defined for that platform according to methods described herein is returned by a web server, which may be a proxy server 400.

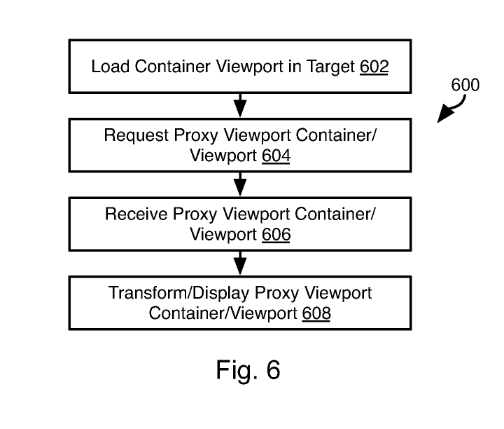

FIG. 6 illustrates a method 600 by which a user device may access content of a client that has been processed according to method described herein, such as described above with respect to FIG. 3. The method 600 may be executed by a user device or some other device that provides an interface to the user device.

The method 600 may include loading 602 a web page that includes the container viewport. As noted above, the container viewport references as a source thereof one of the proxy viewport container 504 and proxy viewport 506. Accordingly, a browser rendering the web page may request 606 the proxy viewport container 504 from the proxy server 400 and/or viewport using the reference. The proxy viewport container 504 and/or proxy viewport 506 may be received 606 from the proxy server 400. The proxy viewport container 504 and/or viewport 506 may be transformed 608 and displayed on the user device. For example, using dimensions of the viewport container, the proxy viewport container and/or proxy viewport may be transformed (e.g., scaled and/or translated) to occupy the viewport container. The transformation may take place on the proxy server 400 or on the user device or other device executing the method 600. In some embodiments, the transformation may include applying an overlay appropriate to the target platform as described above with respect to the processing step 306 of FIG. 3. The overlay may be applied by covering or otherwise imposing the overlay (e.g. in a translucent fashion) onto the source content.

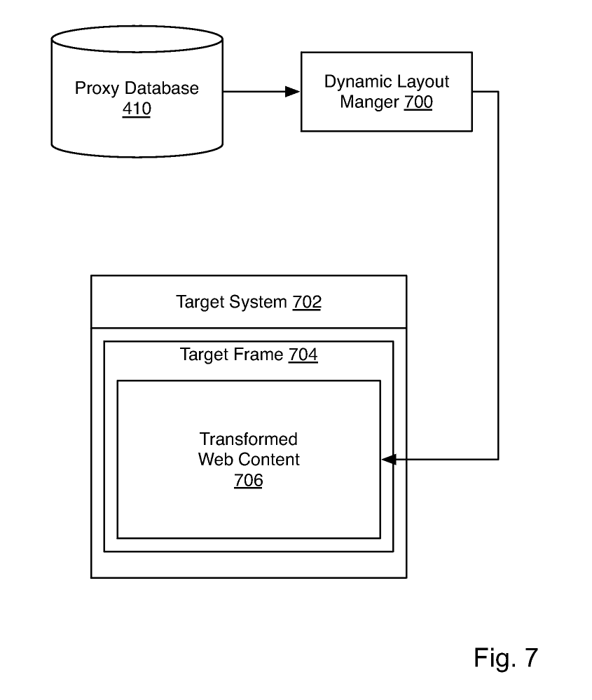

Referring to FIG. 7, a proxy server 400 may host or access a dynamic layout manager 700. The dynamic layout manager 700 may respond to a request for the web page, or for the proxy viewport container 504 and/or viewport 506. For example, the dynamic layout manager 700 may receive a request that is generated by a target system 702 to retrieve the source associated with a container viewport, such as a target frame 704. The request may reference the target platform and/or a size of the container viewport that caused the request. Accordingly, the dynamic layout manager 700 may retrieve the proxy viewport container and/or proxy viewport referenced by the request and transform the proxy viewport container 504 and/or proxy viewport 506 to occupy the viewport container, such as according to the transformations described hereinabove. As noted above, the dynamic layout manager 700 may also apply an overlay to the web page or a selected portion of the web page and present the combined overlay and some or all of the source content of the web page in the proxy view port container 504 and/or proxy viewport 506. The dynamic layout manager may then return the transformed proxy viewport container and/or proxy viewport to the target system 702. The target system 702 may then render the transformed proxy viewport container and/or proxy viewport in the target frame 704 to generate a representation 706 of the transformed web content. As noted above, the transformed proxy viewport container may be an image of the selected content associated therewith.

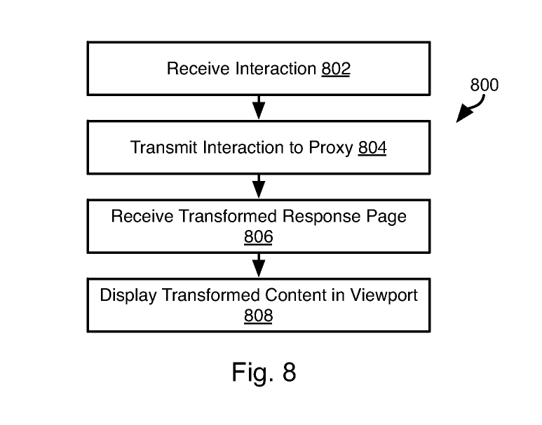

FIG. 8 illustrates a method 800 for responding to user interaction with transformed content displayed on the user device according to the methods described herein, such as a transformed proxy viewport container and/or proxy viewport. The method 800 may be executed by a user device. The method 800 may include receiving 802 interaction by the user with the transformed content on the user device. Inasmuch as the content displayed in the container viewport may be actual HTML code, user interaction may be detected by a browser and the interaction with the link or other element processed accordingly. For example, an element may be a link that invokes a request for content. Accordingly, a request for the content associated with a link or other notification of interaction with an element of the transformed content may be may be transmitted 804 by the user device and received by the proxy server. The proxy server may process the request in accordance with an original web page and transmit a corresponding response as specified by the code defining the original web page. The user device receives 806 this response page and displays it on the user device. In some embodiments, the response may be transformed according to the methods disclosed herein. For example, the response may include a proxy viewport container and/or proxy viewport for display in a container viewport in the same manner as described hereinabove. In some embodiments, the response may be displayed in its original form, e.g., without processing and transformation according to the method 300 or as described herein.

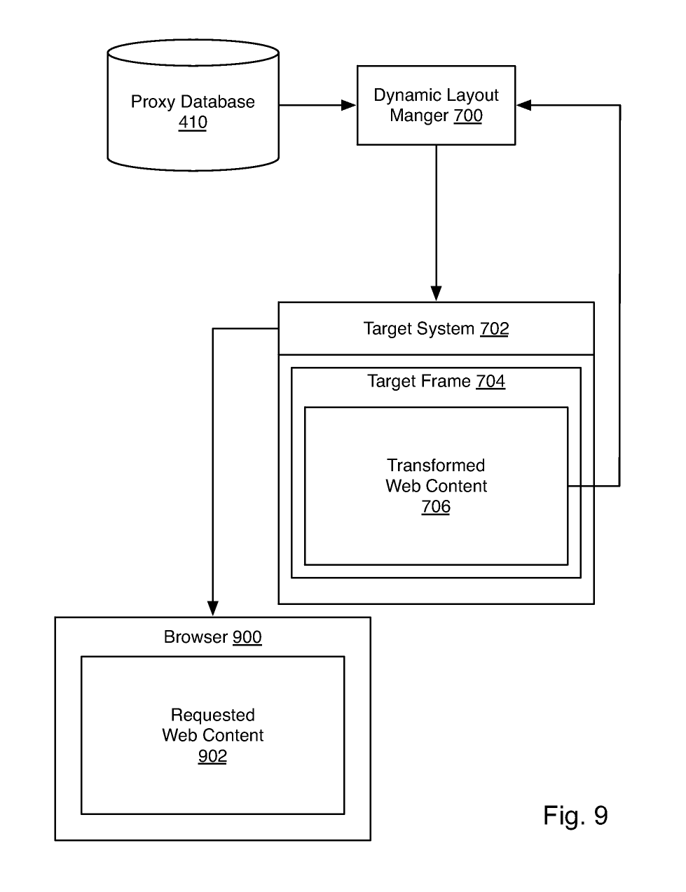

Referring to FIG. 9, for example, a user may interact with transformed web content 706 displayed in a target frame 704 of the target system as described hereinabove. Notification of the user interaction is transmitted to the Dynamic layout manager 700. The dynamic layout manage 700 may retrieve data specified by the original web page code, such as from the proxy database 410 or the client's web server, or other source. The dynamic layout manager 700 then returns the retrieved data (“the response”) to the target system 702. The target system 702 may then display the response in a target frame.

Where the response is not transformed content, such as a proxy viewport container and/or proxy viewport generated as described herein, the response may be rendered by the target system in a browser 900 that displays the requested web content 902 associated the response without limiting what is displayed or otherwise transforming the response according to methods described herein.

Whether the response is transformed or not may be specified in proxy database 410, e.g., if a selection of a portion of the response has been received and the response processed (e.g., sanitized, normalized, associated with a proxy viewport container 504 and/or proxy viewport 506) for subsequent transformation, then the transformed version may be used. Otherwise, the original version may be used.

In some embodiments, the container viewport may include a local content management agent that is written in a language suitable for the target system. For example, for Facebook™ the local content management agent may be written in Javascript.

The local content management agent executes on the user device and may be embedded in the container viewport, proxy viewport container 504, or proxy viewport 506. In some embodiments, the local content management agent performs in-target client content page management functions. For example, upon receiving user interaction with a link and/or receiving a response to such interaction, the local content management agent may remove initial page properties (e.g., iframe properties) of the container viewport and allow pages received subsequent to the transformed content to be loaded and displayed in their full form, such as full website perspective, rather than using coordinates (e.g., X, Y, and Z) coordinates, scaling, and/or transformation defined for the original container viewport, proxy viewport container and/or viewport.

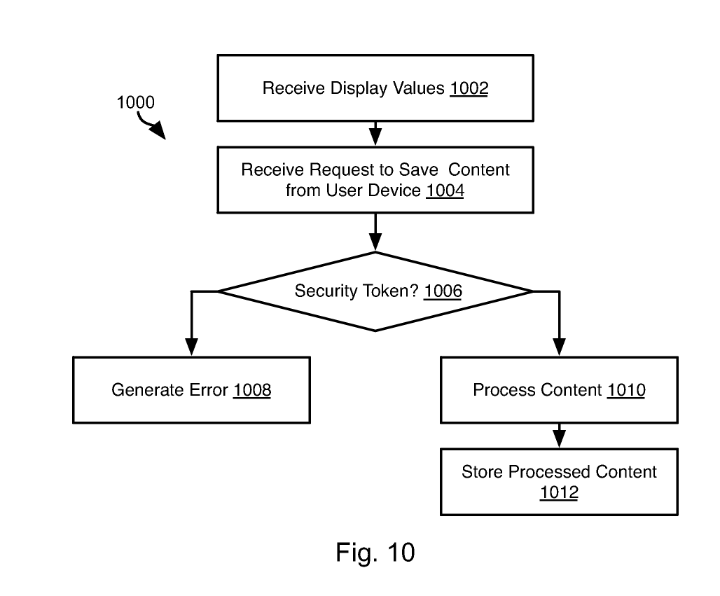

FIG. 10 illustrates an example flow diagram according to example embodiments of the present application. The flow diagram 1000 includes operations that may be performed by a server as it receives requests and other operational instructions from a client or user device. The server may receive certain display values that identify a user's display area, monitor, operating system, web browser, etc. The display values may be received at operation 1002 and may include a uniform resource locator (URL), scale values needed to size the display area of a new tab or existing browser window, vertical and/or horizontal size values and offset values, height values, image URL and reward URL information, such as the present URL of the website and the imported information from the reward or advertisement website, etc. The server may also receive a request 1004 from the client device to save new content at the application server to be shared via the user's access of the social networking site. The new content may be a portion of a web page referenced by a URL. The display values may specify what portion of the web page corresponds to the promotion. The new content may be a promotion. Other content that is other than a promotion may be specified.

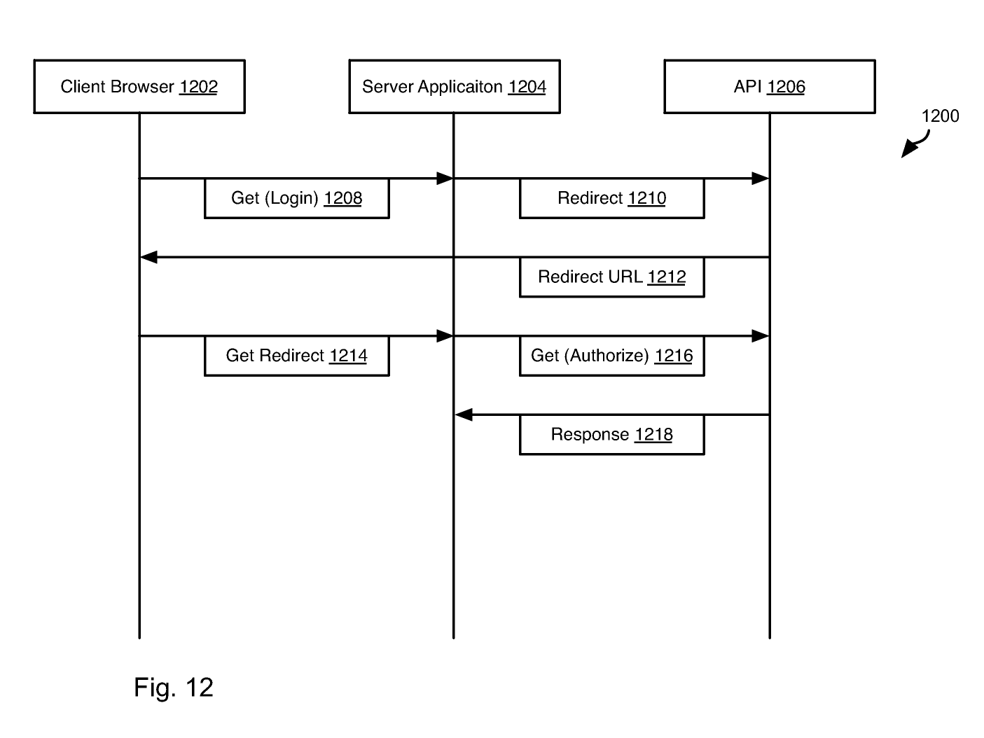

In operation, a client may request content be uploaded and save to the user's account on the advertisement server. A security token may be sought 1006 by the server and if it does not exist then the process may end in an error or login error 1008. The token may provide a login credential that then allows all uploaded data to be processed 1010, e.g., sanitized and normalize to remove any viruses, attachments or other hazardous data before combining the display data attributes received with the new advertisement information. The user data, such as login, social network site login, page data, etc. may all be stored 1012 in memory, such has a proxy database 410, and retrieved when a client is trying to create an advertisement to share through their social networking account. A customer may use an advertisement builder application to incorporate their new advertisement into their existing social network account. The result may produce a simulated social network site tab that displays the advertisement in full size and keeps the site login active and incorporated into the border of the new tab that is generated (see FIG. 12).

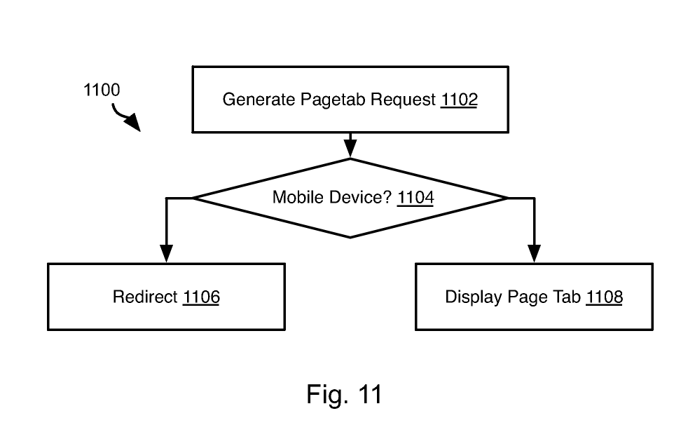

FIG. 11 illustrates another example flow diagram 1100 according to example embodiments of the present application. When the server receives 1102 a page tab request a determination may be made 1104 as to whether the end device is mobile or not which will modify the display content accordingly or cause 1106 a redirect if the device is a mobile device and will launch a display page tab. If not, an original page tab may be displayed 1108, since the display area can be launched as a new tab in the larger computing device display area.

In order to generate the new page tab with the advertisement while preserving the original application content, two HTML entities are required. The first HTML entity has a fixed width and a hidden overflow property and a higher Z-index than the element contained inside. The second element may be an iFrame element which has applied values from within the database catered and normalized to the user's browser and its corresponding version. The process may include a CSS transform that is browser specific.

FIG. 12 illustrates an example system communication flow diagram according to example embodiments of the present application. The client's browser and corresponding computing device 1202 may interface with an application 1204 that is operating on the server 102a. The user may transmit a GET message 1208 to login to the application that is operating as an agent on the client's device 1202 but which communicates with the server 102a. The message may be received by the application 1204 and processed as a redirect 1210 to an API 1206 of a host application (e.g., social network site, such as Facebook™, LinkedIn™, etc.). The API 1206 may provide a redirect URI 1212 that provides access to the user's social network application account. A GET redirect URI 1214 may be transmitted from the user browser 1202 and which is received and processed by the application 1204 which seeks access to the API 1206 via another GET message 1216. The API 1206 may transmit back a response 1218 indicating access to the application via the API 1206.

In operation, the user may access his or her browser 310 to seek access to the social network site and to offer an advertisement to his or her group of contacts. The advertisement may be posted and retrieved as a new tab preserved within the same application interface as illustrated in FIG. 3B. In order to accomplish this setup, the page tab must be based on the two HTML entities. A scale operation provides a way to identify the browser type and provide an accurately sized advertisement page tab inside the current API interface of the social networking application.

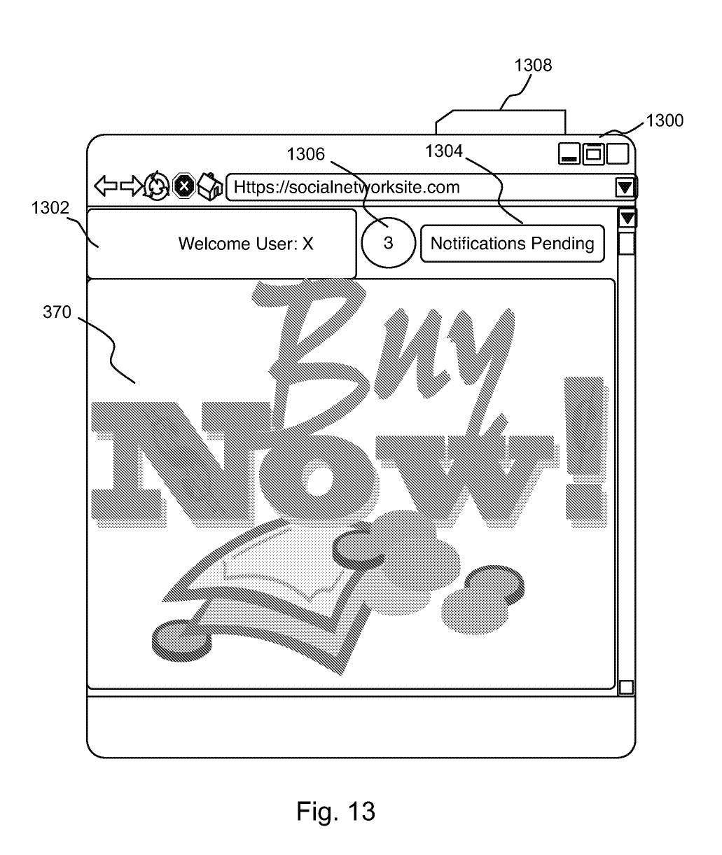

FIG. 13 illustrates an example graphical user interface including the application tab and imported advertisement according to example embodiments of the present application. The user interface window 1300 may represent a social network website with a user logged into the application as denoted by the welcome display tag 1302 and the notifications pending status 1304 and counter 1306. The entire display may be a replica of an initial login page but which was regenerated as a new tab 1308 in a user's Internet browser to include a full-sized advertisement. In this example, a user may have logged into their social networking site and may have clicked on an advertisement that was shared via a user of the advertisement application of the present application. As a result, the user's browser may have opened a new tab to include the advertisement in a large-scale view 370 based on the display properties of the user's machine, the browser, and other attributes identified in the above-noted examples.

Example embodiments provide a method and apparatus of displaying an advertisement on a display interface and more specifically to proxying a user's view of a social website business page tab (Facebook™) that may have a fixed width (e.g., 810 pixels) to an existing application display which may be more than the fixed number of pixels of the website. The application may also perform proxying or applying of visual filters as they apply to a zoom or scale operation, a hidden content function (e.g., offsets), and vertical and horizontal adjustments.

The adjustments may be CSS properties measured in pixels or a percent applied specifically to a relative and absolute position(s), height of a viewport, scale (either decimal, percent or floating point integer), width, which may be unique as it operates with the scale. In one example, A tab page, a SaaS driven Iframe and a user supplied URL provides a conventional approach to offering content. However, a tab page with a SaaS driven iFrame and a user supplied URL/scale/offsets may provide a novel advertisement display function.

Social website functionality, in its current state, (e.g., Facebook™) requires users to make specific “landing pages” to use a page tab. Therefore, the user is expected to develop this page to meet the requirements for what fits inside of the application website. This application function may accept arguments (data segments), to generate a visual filter. The application functionality does not relay the requests, but rather creates a micro-window (iframe) for the user to communicate directly to the software as a service (SaaS) offer.

In fact the proxied iFrame could be an entire SaaS on its own by advertisers to scale advertisements and even sectors of advertisements. Also, the end user can subscribe to the analytic reporting to understand about the user who clicks on the advertisement category. According to another example embodiment, if the “fixed” 810 pixels are removed and specified dimensions are provided then the corresponding advertisements and other data that is incorporated into the web page application may be expanded to accommodate numerous options and the mobile device integration may also be expanded to accommodate the smaller display monitors on such devices. Another potential embodiment would be the generation of static images (e.g., .jpg .png, etc.) using the “proxied” viewport approach.

The present invention may be embodied in other specific forms without departing from its spirit or essential characteristics. For example, although visualization of a network topology is disclosed, any representation of interconnected elements may be visualized according to methods disclosed herein. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A method for providing access to content, the method comprising, by a proxy server:
receiving at least one of a reference to the content and the content from a client device;
receiving a selection of a selected portion of the content from the client device;
generating a target viewport suitable for a target platform;
transforming at least a portion of the content to generate a transformation such that the transformation represents the selected portion;
associating the transformation with the target viewport; and
publishing the target viewport for access over a network by a browser.

2. The method of claim 1, wherein the target viewport includes a container that is a hypertext markup language element, the method further comprising defining a reference to the transformation in the target viewport as a source of the viewport.

3. The method of claim 2, further comprising storing the transformation in a database such that the transformation is addressable by means of the reference to the transformation.

4. The method of claim 1, wherein the transformation includes at least one of zooming and translating operations with respect to the content such that a non-selected portion of the content is outside of the boundary.

5. The method of claim 1, wherein the transformation includes removing fixed dimensions in at least the selected portion and replacing the fixed dimensions with scalable values.

6. The method of claim 1, wherein the transformation includes a cascading style sheet (CSS) scale transformation.

7. The method of claim 1, wherein the transformation includes applying an overlay to at least one of the content and the selected portion, the overlay corresponding to the target platform.

8. The method of claim 1, wherein the target container is a first target container, and the target platform is a first target platform, the method further comprising:
generating a second target container suitable for a second target platform;
associating the transformation with the second target container; and
publishing the second target container for access over a network by means of a browser

9. The method of claim 8, the method comprising:
receiving a request for the content from a user device;
identifying a requesting platform associated with the request;
identifying one of the first and second target platforms as corresponding to the target platform; and
transmitting whichever of the first and second target containers corresponds to the requesting platform to the user device.

10. The method of claim 1, wherein publishing the target container comprises adding the container to a social media interface associated with a same entity as the client device.

11. The method of claim 1, further comprising:
receiving a request for the content from a user device;
identifying a requesting platform associated with the request as the target platform;
transmitting the transformation to the user device;
receiving notification of interaction with the transformation on the user device; and
determining a response to the interaction based on the content;
transmitting the response to the user device.

12. The method of claim 11, wherein the response is not transformed according to the target platform.

13. A method for accessing content, the method comprising, by a user device:
requesting a web page from a first server;
receiving from one of a second server and the first server, a container including a reference to a transformation of the web page, the transformation including less than all of the visible content of the web page;
requesting, from the second server, in response to the reference, the transformation using the reference;
receiving, from the second server, the transformation; and
rendering the transformation within the container.

14. The method of claim 13, wherein the user device is a mobile phone.

15. The method of claim 13, wherein requesting the web page from the first server includes requesting a social media interface including the target container.

16. The method of claim 13, further comprising:
receiving user interaction with a representation of the transformation;
transmitting notification of the interaction to the second server;
receiving, from the first server, an untransformed response to the interaction;
rendering the untransformed response on the user device.

17. The method of claim 13, wherein the transformation is a cascading style sheet (CSS) transformation of the web page in which only a selected portion of the web page is viewable.

18. A system for providing access to content, the system comprising one or more processors and one or more memory devices in data communication with the one or more processors, the one or more memory devices storing executable and operational data effective to cause the one or more processors to:
receive at least one of a reference to a web page and the web page from a client device;
receive a selection of a selected portion of the web page from the client device;
generate a target container suitable for a target platform;
transform at least a portion of the web page to generate a transformation such that the transformation represents the selected portion and is presentable within a boundary associated with the target container;
associate the transformation with the target container; and
publish the target container for access over a network by a browser.

19. The system of claim 18, wherein transformation includes a proxy viewport container, the executable and operational data being further effective to cause the one or more processors to:
define a viewport within the container, the target container including a reference to the proxy viewport container as a source thereof.

20. The system of claim 18, wherein the server is configured as a software as a service (SaaS) platform.
